(19) United States
(12) Patent Application Publication
(10) Pub. No.: US 2009/0314711 A1
(43) Pub. Date: Dec. 24, 2009

(54) PHOTOELECTROCATALYTIC OXIDIZER DEVICE HAVING COMPOSITE NANOPOROUS TiO2 COATED Ti PHOTOANODE AND METHOD OF REMOVING AMMONIA FROM WATER IN AQUARIA AND RECIRCULATION AQUACULTURE SYSTEMS

(76) Inventors: Terence P. Barry, Middleton, WI (US); Dean T. Tompkins, Madison, WI (US); Marc A. Anderson, Madison, WI (US); Walter A. Zeltner, Oregon, WI (US)

Correspondence Address: Patent Docket Department;Armstrong Teasdale LLP, One Metropolitan Square, Suite 2600, St. Louis, MO, 63102-2740, US

(21) Appl. No.: 12/369,219

(22) Filed: Feb. 11, 2009

Related U.S. Application Data
(60) Provisional application No. 61/027,622, filed on Feb. 11, 2008.

(51) Int. Cl. A01K 63/04

(52) U.S. Cl. 210/629; 210/167.21

(57) ABSTRACT

A photoelectrocatalytic oxidizing device having a photoanode being constructed from an anatase or rutile polymorph of Ti as the support electrode. Alternatively, the photoanode is a composite electrode comprising an anatase or rutile polymorph of Ti as the support electrode coated with a thin film of sintered nanoporous TiO₂ derived from a stable, dispersed suspension of nanoparticulate TiO₂. The device being useful for removing ammonia, protein and other contaminants from water in aquariums and aquacultures thereof. The device being cylindrical in shape and having a flow-through configuration. The method being directed at reducing the amount and concentration of ammonia in an aquarium or aquaculture system comprising providing an aqueous solution comprising water, NH₃, NH₄⁺ and 1 ppb to 200 g/L NaCl, and, photoelectrocatalytically oxidizing the NH₃ and NH₄⁺ to produce N₂ gas, NO₂⁻ and NO₃⁻, wherein the NH₃ and NH₄⁺ are oxidized on the surface of a photoanode constructed from an anatase polymorph of Ti, a rutile polymorph of Ti, or a nanoporous film of TiO₂.

### CROSS REFERENCE TO RELATED APPLICATIONS

This application claims priority to and benefit of U.S. Provisional Patent Application Ser. No. 61/027,622 filed Feb. 11, 2008, which is hereby incorporated herein by reference in its entirety.

This application is related to commonly-owned U.S. patent application Ser. No. 11/932,741, which is hereby incorporated by reference.

This application is related to commonly-owned U.S. patent application Ser. No. 11/932,519, which is hereby incorporated by reference.

### STATEMENT REGARDING GOVERNMENT INTEREST

Funding was received under SBIR Grant No. 2007-33610-18003 from the U.S. Department of Agriculture. The U.S. Government has certain rights in this invention.

### BACKGROUND OF THE INVENTION

Water recirculation systems are expected to play a key role in the expansion of aquaculture production in the United States because they provide year-round production of aquatic organisms under controlled conditions. Closed recirculation systems require little water and land, have minimal effluent discharge, and, can be constructed and operated almost anywhere including within cities close to major markets. Closed hatchery systems can also be operated in a biosecure manner unlike other forms of aquaculture.

Fish sensitivity to ammonia and nitrite toxicity is a major factor limiting expansion of an environmentally sustainable aquaculture industry reliant on water recirculation technology. Closed recirculating aquaculture systems provide year-round fish production under controlled conditions. Pond, net-pen and flow-through culture systems require significantly more water and land. In contrast, very little water and land are needed for closed, recirculating aquaculture systems, which also yield minimal effluent discharge.

Closed, recirculating aquaculture systems may also be advantageously constructed and operated in cities proximate to major markets. At present, however, it is more cost effective to produce food fish in ponds and other open systems due to the high cost of building and operating complex biofiltration units, which are currently required for effective recirculation systems.

Currently, however, recirculation aquaculture is generally unfavorable economically primarily because of the high costs of constructing and operating the complex systems required for water circulation, solids capture, oxygenation, and nitrogenous waste removal. Nitrogenous waste removal is particularly problematic. Numerous technological approaches have been attempted to remove ammonia from recirculated water including trickle filters, rotating drums, and floating bead filters.

Disadvantages of biofilters include a high concentration of nitrates, a compromise between fish and bacteria for optimal growing conditions (e.g., temperature), and bacterial growth that clogs filter pores and reduces filtration efficiency. Cleaning of biofilters can also reduce bacterial populations. New biofilters take 4-6 weeks to become operational, and, for this reason, biofilters cannot be used intermittently. Still other disadvantages include disturbances such as adding more fish or overfeeding fish that lead to spikes in ammonia, and difficulty in treating sick fish with antibiotics which may also kill beneficial nitrifying bacteria populations on the biofilters.

Aquaria and recirculation aquaculture systems generally have few or no anoxic zones. Therefore, nitrates must be removed by periodic water exchanges. Optimization is difficult because aquaculture biofiltration systems require good growing conditions for both the fish and bacteria. However, optimal temperatures for fish growth may be suboptimal for nitrifying bacteria. Existing biofiltration systems used in aquaria and other aquaculture systems have numerous other limitations. For example, autotrophic nitrifying bacteria and competing heterotrophic bacteria colonize within biofilters clogging filter pores and reducing nitrification efficiency.

In general, sufficient nitrifying bacteria populations require around 6 weeks to establish in new biofilters. Therefore, current systems cannot filter intermittently. The filters must be operated even if there are temporarily no fish in the system to maintain biofilter activity. Even minor disturbances (such as tank cleaning, overfeeding, or adding new fish) can disrupt delicate nitrifying bacteria population equilibrium leading to ammonia spikes. Sick fish cannot be treated with antibiotics because antibiotics kill nitrifying bacteria.

Such limitations associated with biofiltration systems curtail the production of aquatic organisms in water reuse systems. Autotrophic nitrifying bacteria and heterotrophic bacteria can colonize the biofilters, which clog filter pores and reduce the efficiency of nitrification. Biofilters are difficult to clean without reducing the beneficial bacterial populations. Nitrifying bacteria grow slowly taking weeks for sufficient populations of nitrifying bacteria to become established in new biofilters. Even minor disturbances, such as tank cleaning, overfeeding, or adding new fish, can disrupt the delicate equilibrium of the nitrifying bacteria populations leading to spikes in ammonia. Nitrates accumulate in the water, which stimulates the production of nuisance algae. Nitrates can only be removed from the closed system by periodic water exchange. Such problems increase maintenance time and costs in all systems as well as salt disposal problems associated with seawater systems.

Nitrogenous waste removal in open systems is particularly problematic. Numerous approaches have been investigated, including trickle filters, rotating drums, and floating bead filters. (Abeysinghe D et al., 1996, Biofilters for water reuse in aquaculture, Water Sci. Technol. 34:253-260; deLosReyes A et al., 1996, Combination of a bead filter and rotating biological contactor in a recirculating fish culture system, Aquacul. Eng. 15:27-39; Van Rijn J, 1996, The potential for integrated biological treatment systems in recirculating fish culture-A review, Aquacul. 139:181-201; and, Malone R et al., 2000, Use of floating bead filters to recondition recirculating waters in warm water aquaculture production systems, Aquacul. Eng. 22:57-73).

Other methods for eliminating nitrogenous wastes utilize biological processes based on bacterial nitrification and de-nitrification. (Cooper P et al., 1994, Process options for phosphorus and nitrogen removal from wastewater, J. Inst. Water Environ. Manag. 8:84-92). Ammonia converts to nitrate using two types of aerobic autotrophic bacteria. One bacteria oxidizes ammonia to nitrite (NO₂⁻), and the other converts nitrite to nitrate (NO³⁻).

Under anoxic conditions, heterotrophic denitrifying bacteria reduce nitrite and nitrate to nitrogen gas. Autotrophic ammonia-oxidizing bacteria are generally characterized by low growth rates and yields. In general, nitrification is the rate-limiting step in biological nitrogen removal processes. Maintaining adequate levels of nitrifiers is a significant problem in biological removal processes.

Nitrifiers and de-nitrifiers require different environmental conditions for growth. In wastewater treatment plants, total nitrogen removal is commonly achieved using a two-stage system. Both steps can, however, occur simultaneously in a single reactor. (Helmer C et al., 1998, Simultaneous nitrification/denitrification in an aerobic system, Water Sci. Technol. 37:183-187).

Zebrafish rearing systems are used extensively in biomedical research. Bacterial metabolites associated with and produced by biofilters can adversely affect physiological responses of certified disease-free fish strains. Thus, there is an absence or shortage of certified disease-free zebrafish.

Electrochemical oxidation has been an alternative approach to solving the ammonia removal problem. (Chen D, 2004, Electrochemical technologies in wastewater treatment, Sep. Purif Technol. 38:11-41). Electrochemical oxidation (as opposed to photoelectrochemical oxidation) is an alternative approach to solving the ammonia removal problem. Such methods, which utilize electrodes and electrical potentials to oxidize nitrogenous compounds, are attractive because they can overcome many of the drawbacks of biological techniques. Electrochemical methods produce little or no sludge, can work with high or variable pollutant concentrations, and are generally unaffected by the presence of impurities.

Electrochemical oxidation systems and processes employ electrodes and electrical potential to oxidize nitrogenous compounds. In principle, oxidation can be controlled by applying particular voltages. In the general sequence of increasing voltages ammonium is oxidized to higher oxidation states in the order of ammonium (NH₄⁺), nitrogen gas (N₂), nitrite (NO₂⁻) and nitrate (NO₃⁻). Ideally, one would like to oxidize ammonium to nitrogen gas which would then exit the system. However this has not normally been possible using electrochemical systems. Electrochemical oxidation systems produce little or no sludge. Electrochemical oxidation systems also treat high and/or variable pollutant concentrations. Such systems are also substantially unaffected by the presence of impurities. Use of an electrochemical oxidation process to remove 100% of ammonia (2600 mg/L) in a landfall leachate has been reported. (Chiang L et al., 1995, Indirect oxidation effects in electrochemical oxidation treatment of landfill leachate, Water Res. 29:671-678).

During electrochemical oxidation, the concentration ratio HClO:N₂ and pH influence the production rate of chloramines such as NH₂Cl, NHCl₂ and NCl₃. The efficiency of ammonia oxidation through in situ production of hypochlorite has been reported. (Lin S H et al., 1996, Electrochemical removal of nitrite and ammonia for aquaculture, Water Res. 30, 715-721; Lin S et al., 1997, Electrochemical nitrite and ammonia oxidation in seawater, J. Environ. Sci. Health, Part A A32:2125-2138).

However, several oxygen-containing anions are generated during electrochemical oxidation, such as SO₄²⁻, ClO₃⁻ and ClO₄⁻, and these specie inhibit the formation of ClO⁻ ions, which slows the destruction/oxidation of ammonia. (Czarnetzki L et al., 1992, Formation of hypochlorite, chlorate and oxygen during NaCl electrolysis from alkaline-solutions at a RuO₂/TiO₂ anode, J. Appl. Electrochem. 22:315-324; and, Chiang H et al., 1996, Photodegradation of chlorinated organic wastes with N—TiO₂ promoted by P—CuO, J. Chinese Chem. Soc. 43:21-27). When ammonia is chlorinated, final products may include toxic chlorine gas and explosive nitrogen trichloride. Moreover, the electrochemical method may require high levels of energy, and chloride ions must be added to the system for the method to work. The electrodes may also require titanium-based boron-doped diamond film electrodes (Ti/BDD) that demonstrate high activity and reasonable stability. However, such electrodes are very expensive. Other alternatives to biological filtration, such as ammonia stripping and ion exchange, are impractical or uneconomical in most circumstances.

### SUMMARY OF THE INVENTION

One aspect of the invention is a photoelectrocatalytic composite photoanode comprising a solid nanoporous film member having a median pore diameter in the range of 0.1-500 nanometers constructed from TiO₂ nanoparticles, the nanoporous film member adhered to a conductive support member.

In an exemplary embodiment of the photoelectrocatalytic composite photoanode, the median pore diameter is in the range of 0.3-25 nanometers.

In another exemplary embodiment of the photoelectrocatalytic composite photoanode, the median pore diameter is in the range of 0.3-10 nanometers.

In another exemplary embodiment of the photoelectrocatalytic composite photoanode, the nanoporous film member has an average thickness in the range of 1-2000 nm.

In another exemplary embodiment of the photoelectrocatalytic composite photoanode, the nanoporous film member has an average thickness in the range of 5 to 500 nm.

In another exemplary embodiment of the photoelectrocatalytic composite photoanode, the nanoporous film member is constructed from a stable, dispersed suspension comprising TiO₂ nanoparticles having a median primary particle diameter in the range of 1-50 nanometers. The nanoporous film may also be deposited by other methods, such as plasma, chemical vapor deposition or electrochemical oxidation.

In another exemplary embodiment of the photoelectrocatalytic composite photoanode, the TiO₂ nanoparticles have a median primary particle diameter in the range of 0.3-5 nanometers.

In another exemplary embodiment of the photoelectrocatalytic composite photoanode, the nanoporous film member is constructed from a stable, dispersed suspension further comprising a doping agent.

In another exemplary embodiment of the photoelectrocatalytic composite photoanode, the doping agent is Pt, Ni, Au, V, Sc, Y, Nb, Ta, Fe, Mn, Co, Ru, Rh, P, N or carbon.

In another exemplary embodiment of the photoelectrocatalytic composite photoanode, the conductive support member is annealed titanium foil. Other conductive supports may be employed, such as conductive carbon or glass.

In another exemplary embodiment of the photoelectrocatalytic composite photoanode, the nanoporous film member is constructed by applying a stable, dispersed suspension having TiO₂ nanoparticles suspended therein, and, the TiO₂ nanoparticles are sintered at a temperature in the range of 300° C. to 1000° C. for 0.5 to 10 hours to produce the nanoporous film member.

In another exemplary embodiment of the photoelectrocatalytic composite photoanode, the stable, dispersed suspension is made by reacting titanium isopropoxide and nitric acid in the presence of ultrapure water or water purified by reverse osmosis, ion exchange, and one or more carbon columns.

In another exemplary embodiment of the photoelectrocatalytic composite photoanode, the photoelectrocatalytic composite photoanode is cylindrical in shape.

Another aspect of the invention is a photoelectrocatalytic oxidation device for use in an aquarium or aquaculture comprising any one of the above photoelectrocatalytic composite photoanodes, a cathode, a housing member having an inlet and outlet adapted to house the anode and cathode, a light source assembly adapted to emit ultraviolet light to the photoelectrocatalytic composite photoanode, and, an electrical power source adapted to apply a voltage across the photoelectrocatalytic composite photoanode and cathode in the range of −1 V to +12 V.

In an exemplary embodiment of the photoelectrocatalytic oxidation device, the cathode is constructed from Pt, Ti, Ni, Au, stainless steel or carbon.

In another exemplary embodiment of the photoelectrocatalytic oxidation device, the cathode is in the shape of a wire, plate or cylinder.

In another exemplary embodiment of the photoelectrocatalytic oxidation device, the device further comprises a reference electrode and a voltage control device, such as a potentiostat, adapted to maintain a constant voltage or constant current between the reference electrode and the photoelectrocatalytic composite photoanode, whereby the housing member is adapted to house the reference electrode.

In another exemplary embodiment of the photoelectrocatalytic oxidation device, the device further comprises a semi-micro saline bridge member connecting the potentiostat and reference electrode, whereby the housing member is adapted to house the saline bridge.

In another exemplary embodiment of the photoelectrocatalytic oxidation device, the reference electrode is constructed from silver and is in the shape of a wire.

In another exemplary embodiment of the photoelectrocatalytic oxidation device, the device further comprises a carbon filter adapted to filter chlorine from the water, and, a computer adapted to send a controlled signal to the existing power supplies to pulse the voltage and current.

In another exemplary embodiment of the photoelectrocatalytic oxidation device, the housing member is adapted to house the light source assembly and the electrical power source is adapted to generate an electrical potential in the range of 1.2 V to 3.5 V across the photoelectrocatalytic composite photoanode and cathode (or, 0 to 2.3 V vs the reference electrode).

Alternatively, the instant device may employ both constant current and/or constant voltage between anode and cathode. The effective voltage range may be in the range of −1 V to +12 V.

In another exemplary embodiment of the photoelectrocatalytic oxidation device, the light source assembly comprises a lamp or bulb and a transparent quartz or fused silica member adapted to house the lamp, and the ultraviolet light has a wavelength in the range of 200-380 nm. The device will also function using sunlight instead of the light source assembly.

In another exemplary embodiment of the photoelectrocatalytic oxidation device, the lamp is adapted to emit germicidal UVC or black light UVA.

In another exemplary embodiment of the photoelectrocatalytic oxidation device, the germicidal UVC emits a peak wavelength of 254 nm, and the black light UVA emits a wavelength in the range of 300-380 nm.

The photoelectrocatalytic oxidation device of claim 22, wherein the lamp is a low pressure mercury vapor lamp adapted to emit UV germicidal irradiation at 254 nm wavelength.

In another exemplary embodiment of the photoelectrocatalytic oxidation device, the lamp is adapted to emit an irradiation intensity in the range of 1-500 mW/cm². The irradiation intensity varies considerably depending on the type of lamp used. Higher intensities improve the performance of the photoelectrocatalytic oxidation (PECO) device. The intensity can get so high that the system is swamped and no further benefit is obtained. That value depends upon the distance between the light and the photoanode.

In another exemplary embodiment of the photoelectrocatalytic oxidation device, the light source assembly is disposed exterior to the housing member, and the housing member further comprises a transparent member adapted to permit ultraviolet light emitted from the light source assembly to irradiate the photoelectrocatalytic composite photoanode.

Another aspect of the invention is a method of reducing the amount and concentration of ammonia in an aquarium or aquaculture comprising the steps or acts of providing an aqueous solution comprising water, NH₃, NH₄⁺ and 1 ppb to 200 g/L NaCl, and, photoelectrocatalytically oxidizing the NH₃ and NH₄⁺ to produce N₂ gas, NO₂⁻ and NO₃⁻.

In an exemplary embodiment of the method of reducing the amount and concentration of ammonia in an aquarium or aquaculture, the aqueous solution has a pH in the range of 5 to 10.

In another exemplary embodiment of the method of reducing the amount and concentration of ammonia in an aquarium or aquaculture, the aqueous solution comprises 1 to 41 g/L NaCl.

In another exemplary embodiment of the method of reducing the amount and concentration of ammonia in an aquarium or aquaculture, the aqueous solution comprises in the range of 0.05 ppb to 9 ppm NH₃ and NH₄⁺ as nitrogen.

In another exemplary embodiment of the method of reducing the amount and concentration of ammonia in an aquarium or aquaculture, NH₃ and NH₄⁺ are photoelectrocatalytically oxidized using a voltage in the range of −1 V to +12 V.

In another exemplary embodiment of the method of reducing the amount and concentration of ammonia in an aquarium or aquaculture, NH₃ and NH₄⁺ are photoelectrocatalytically oxidized using a voltage in the range of 1.2 to 3.5 V.

In another exemplary embodiment of the method of reducing the amount and concentration of ammonia in an aquarium or aquaculture, NH₃ and NH₄⁺ are photoelectrocatalytically oxidized using sunlight or ultraviolet light having a wavelength in the range of 200 to 380 nm.

In another exemplary embodiment of the method of reducing the amount and concentration of ammonia in an aquarium or aquaculture, the ultraviolet light is germicidal UVC having a peak wavelength of 254 nm or black light UVA having a wavelength in the range of 300-380 nm.

Another aspect of the invention is an aquarium comprising a fish tank and any one of the above photoelectrocatalytic oxidation devices.

Another aspect of the invention is a photoelectrocatalytic uncoated anode constructed from an anatase polymorph of Ti or a rutile polymorph of Ti.

In an exemplary embodiment of the photoelectrocatalytic uncoated anode, the uncoated anode is constructed from the rutile polymorph of Ti.

In another exemplary embodiment of the photoelectrocatalytic uncoated anode, the rutile polymorph of Ti is constructed by heating an anatase polymorph of Ti at a temperature in the range of 300° C. to 1000° C. for a sufficient time.

In another exemplary embodiment of the photoelectrocatalytic uncoated anode, the anatase polymorph of Ti is heated at 500° C. to 600° C. to produce the rutile polymorph of Ti.

In another exemplary embodiment of the photoelectrocatalytic uncoated anode, the uncoated anode is configured as a foil.

In another exemplary embodiment of the photoelectrocatalytic uncoated anode, the uncoated anode is further configured as cylindrical in shape.

Another aspect of the invention is a photoelectrocatalytic oxidation device for use in an aquarium or aquaculture comprising any one of the above photoelectrocatalytic uncoated anodes, a cathode, a housing member having an inlet and outlet adapted to house the uncoated anode and cathode, a light source assembly adapted to emit ultraviolet light to the photoelectrocatalytic uncoated anode, and, an electrical power source adapted to apply a voltage across the photoelectrocatalytic uncoated anode and cathode in the range of −1 to +12 V.

In an exemplary embodiment of the photoelectrocatalytic oxidation device, the cathode is constructed from Pt or Ti.

In another exemplary embodiment of the photoelectrocatalytic oxidation device, the cathode is constructed from Pt, Ti, Ni, stainless steel or carbon, and the cathode is in the shape of a wire or a plate or a cylinder.

In another exemplary embodiment of the photoelectrocatalytic oxidation device, the device further comprises a reference electrode and a potentiostat adapted to maintain a constant voltage between the reference electrode and the photoelectrocatalytic uncoated anode, and the housing member is adapted to house the reference electrode.

In another exemplary embodiment of the photoelectrocatalytic oxidation device, the device further comprises a semi-micro saline bridge member connecting the potentiostat and reference electrode, and the housing member is adapted to house the saline bridge.

In another exemplary embodiment of the photoelectrocatalytic oxidation device, the reference electrode is constructed from silver.

In another exemplary embodiment of the photoelectrocatalytic oxidation device, the reference electrode is in the shape of a wire.

In another exemplary embodiment of the photoelectrocatalytic oxidation device, the housing member is adapted to house the light source assembly, and the electrical power source is adapted to generate an electrical potential in the range of 1.2 to 3.5 V across the photoelectrocatalytic uncoated anode and cathode.

In another exemplary embodiment of the photoelectrocatalytic oxidation device, the light source assembly comprises a lamp or bulb and a transparent quartz or fused silica member adapted to house the lamp, and the ultraviolet light has a wavelength in the range of 200-380 nm.

In another exemplary embodiment of the photoelectrocatalytic oxidation device, the lamp is adapted to emit germicidal UVC or black light UVA.

In another exemplary embodiment of the photoelectrocatalytic oxidation device, the germicidal UVC emits a peak wavelength of 254 nm, and the black light UVA emits a wavelength in the range of 300-380 nm.

In another exemplary embodiment of the photoelectrocatalytic oxidation device, the lamp is a low pressure mercury vapor lamp adapted to emit UV germicidal irradiation at 254 nm wavelength.

In another exemplary embodiment of the photoelectrocatalytic oxidation device, the lamp is adapted to emit an irradiation intensity in the range of 1-500 mW/cm².

In another exemplary embodiment of the photoelectrocatalytic oxidation device, the light source assembly is disposed exterior to the housing member, and, the housing member further comprises a transparent member adapted to permit ultraviolet light emitted from the light source assembly to irradiate the photoelectrocatalytic uncoated anode.

Another aspect of the invention is a method of reducing the amount and concentration of ammonia in an aquarium or aquaculture comprising the steps or acts of providing an aqueous solution comprising water, NH₃, NH₄⁺ and 1 ppb to 200 g/L NaCl, and, photoelectrocatalytically oxidizing the NH₃ and NH₄⁺ to produce N₂ gas (as well as insignificant amounts of some by-products such as NO₂⁻ and NO₃⁻), wherein the NH₃ and NH₄⁺ are oxidized on (or proximate to) the surface of a photoanode constructed from an anatase polymorph of Ti, a rutile polymorph of Ti, or a nanoporous film of TiO₂.

In an exemplary embodiment of the method of reducing the amount and concentration of ammonia in an aquarium or aquaculture, the aqueous solution has a pH in the range of 5 to 10.

In another exemplary embodiment of the method of reducing the amount and concentration of ammonia in an aquarium or aquaculture, the aqueous solution comprises 1 to 41 g/L NaCl.

In another exemplary embodiment of the method of reducing the amount and concentration of ammonia in an aquarium or aquaculture, the aqueous solution comprises in the range of 0.05 ppb to 9 ppm NH₃ and NH₄⁺ as nitrogen.

In another exemplary embodiment of the method of reducing the amount and concentration of ammonia in an aquarium or aquaculture, NH₃ and NH₄⁺ are photoelectrocatalytically oxidized by a voltage in the range of −1 V to +12 V.

In another exemplary embodiment of the method of reducing the amount and concentration of ammonia in an aquarium or aquaculture, NH₃ and NH₄⁺ are photoelectrocatalytically oxidized using a voltage in the range of 1.2 to 3.5 V.

In another exemplary embodiment of the method of reducing the amount and concentration of ammonia in an aquarium or aquaculture, NH₃ and NH₄⁺ are photoelectrocatalytically oxidized using sunlight or ultraviolet light having a wavelength in the range of 200 to 380 nm.

In another exemplary embodiment of the method of reducing the amount and concentration of ammonia in an aquarium or aquaculture, the ultraviolet light is germicidal UVC having a peak wavelength of 254 nm or black light UVA having a wavelength in the range of 300-380 nm.

Another aspect of the invention is a photoelectrocatalytic oxidation device for use in an aquarium or aquaculture comprising any one of the photoelectrocatalytic composite photoanodes or uncoated anodes above, a cathode, a housing member having an inlet and outlet adapted to house the anode and cathode, and, an electrical power source adapted to apply a voltage across the photoelectrocatalytic composite photoanode and cathode in the range of −1 V to +12 V, wherein the housing is adapted to permit sunlight to illuminate both the anode or a solar cell adapted to provide the voltage applied across the photoelectrocatalytic composite photoanode and cathode.

Another aspect of the invention is an aquarium containing a fish tank and any one of the above photoelectrocatalytic oxidation devices.

Another aspect of the invention is a closed, recirculating aquaculture system containing any one of the above photoelectrocatalytic oxidation devices.

### BRIEF DESCRIPTION OF DRAWINGS OF EXEMPLARY EMBODIMENTS

FIG. 1 is an electrochemical energy schematic graphically illustrating one embodiment of the photoelectrocatalytic oxidation (PECO) device of the instant invention showing oxidation of ammonia to nitrogen gas, whereby UV light of sufficient energy illuminates a photoanode including a nanoporous titanium dioxide (TiO₂) photocatalyst film coated to a Ti support, whereby electrons in the valence band (VB) are excited into the conduction band (CB) producing highly reactive electrons and holes that promote oxidation of ammonia on the anode surface, whereby the photogenerated electrons preferentially flow to the cathode reducing protons and producing hydrogen gas (H₂) and/or reducing oxygen gas (O₂) and producing water, whereby ΔGₐ is the minimum energy required for the activation of NH₃, whereby ΔG_{cell} is the maximum energy obtained by the device when ΔGₐ is applied, whereby A=applied voltage via a potentiostat, and, whereby the PECO device may include a reference electrode (not pictured).

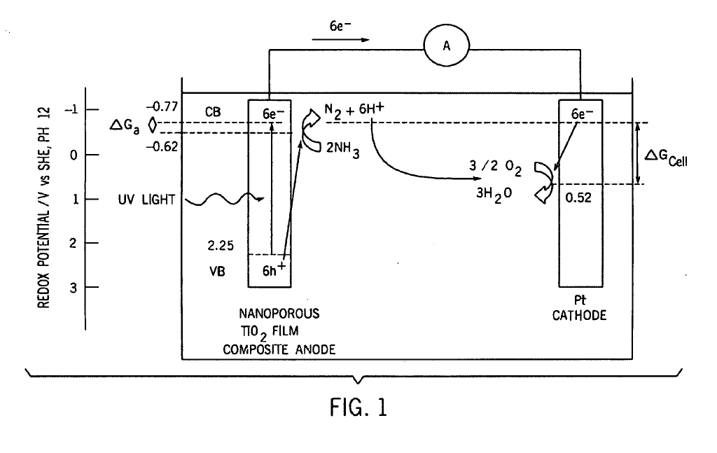

FIG. 2 shows one embodiment of the PECO device of the present invention being a cylindrical flow-through configuration, whereby the device may also be referred to as a photoelectrocatalytic cell.

FIG. 3 is a graphical illustration of a nitrogen cycle for conventional biofiltration systems.

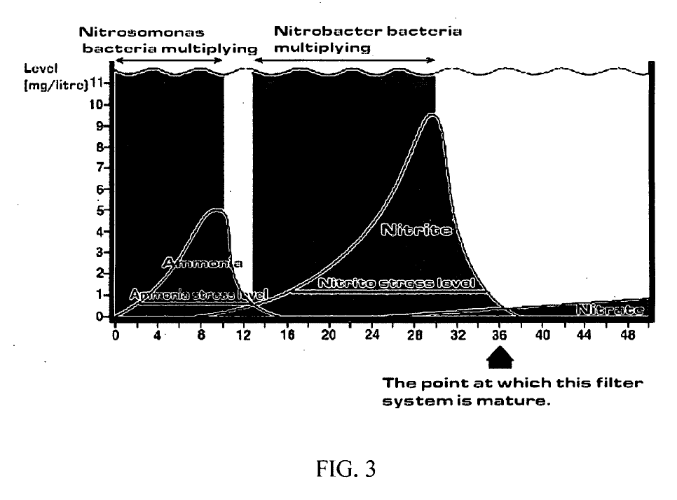

FIG. 4 is another illustration of photoelectrocatalytic oxidation (General for PCO).

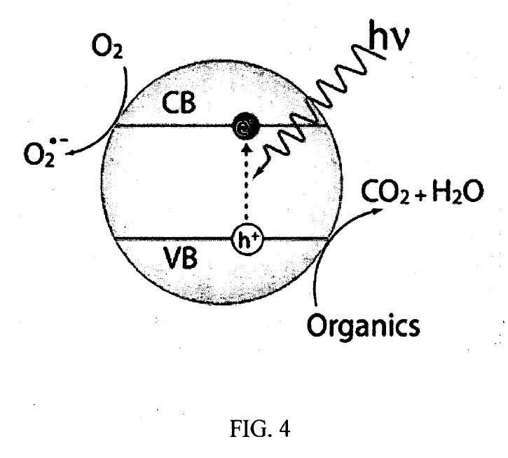

FIG. 5 is a graph showing photocurrent generation as a function of applied potential demonstrating flat band potential of the instant TiO₂-coated Ti composite photoanode (“composite photoanode”) at various initial pH values (pH 4, pH 7 and pH 10) in NaCl solution (4 g/L), whereby linear sweep Vammetry (LSV) triplicate experiment parameters included −1.0 to +1.0 V vs SCE, scan rate 20 mV/s, scan increment of 2.0 mV, step time 0.1 s, and, full spectrum light intensity at 1 W/cm², and whereby control experiments without irradiation produced no current generation.

FIG. 6 is a graph showing ammonia-nitrogen removal as a function of NaCl concentration (0, 0.001, 0.1, 0.25, 1 and 31 g/L)(initial pH 7) using the instant PECO device shown in FIG. 1, whereby triplicate chronoamperometry experiments were conducted, whereby the initial concentration of NH₄⁺ was 0.54 mg/L, whereby the applied potential was +1.0 V vs SCE, and, whereby the composite photoanode was irradiated with full spectrum light intensity at 1.09 W/cm².

FIG. 7 is a graph showing ammonia-nitrogen removal at various light intensities (1.09, 0.60, 0.30 and 0.06 W/cm²) using the instant PECO device shown in FIG. 1, whereby the initial concentration of NH₄⁺ was 0.54 mg/L in 31 g NaCl/L (initial pH 7)(triplicate experiments), whereby full spectrum light was applied, and, whereby the applied potential was +1.0 V vs SCE. The amount of byproducts generated during this test are shown in Table 2.

FIG. 8 is a graph showing ammonia removal from freshwater using the instant PECO device shown in FIG. 1, whereby deionized freshwater (pH 7.4) was spiked with 5 mg/L ammonium chloride, whereby control conditions were the same as the experimental conditions except that photoanode illumination and electric potential were not applied, whereby replicate experiments were performed (N=2 for the controls and N=3 for the experimental), whereby the data shown are the means±standard error of the mean, and whereby the y-axis is the percent of the initial ammonia concentration that remains in the solution at the time shown.

FIG. 9 is a graph showing ammonia removal from salt water using the instant PECO device shown in FIGS. 1 and 2, whereby the y-axis is the decimal fraction of the initial concentration of ammonia that remains in the solution at the time shown.

FIG. 10 is a graph showing ammonia removal using the instant composite photoanode in a static reactor at various number of applied coatings (translating into various film thicknesses) and sintering temperatures of the nanoporous TiO₂ film, whereby the Ti photoanode supports were dip-coated 0, 3 or 5 times in a titania sol and sintered at 300° C. or 500° C., whereby approximately 80 nm to 130 nm TiO₂ is deposited on the titanium support per dip-coating, whereby the experiment was conducted in water containing 1 gram of NaCL per liter of fresh water with aeration, whereby the applied voltage was +1.0 V, whereby the data shown are mean±SEM (N=4), and, whereby the amount of ammonia remaining at given times during the 30-minute tests is shown. (All data reported in FIGS. 10-15 were conducted in freshwater).

FIG. 11 is a bar graph showing nitrate production using the instant composite photoanode in a static reactor at various film thicknesses and sintering temperatures of the nanoporous TiO₂ film, whereby the Ti photoanode supports were dip-coated 0, 3 or 5 times in a titania sol and sintered at 300° C. or 500° C., whereby the experiment was conducted in 100% fresh water (pH 7) with aeration, whereby the applied voltage was +1.0 V, and, whereby the data shown are mean±SEM (N=4).

FIG. 12 is a graph showing ammonia removal using the instant composite photoanode in a static reactor at various film thicknesses and sintering temperatures of the nanoporous Pt-doped TiO₂ film, whereby the Ti photoanode supports were dip-coated 3 or 5 times in a titania sol containing 1% platinum (Pt) and fired at 300° C. or 500° C., whereby the experiment was conducted in 100% fresh water (pH 7) with aeration, whereby the applied voltage was +1.0 V, and, whereby the data shown are mean±SEM (N=4).

FIG. 13 is a bar graph showing nitrate production using the instant composite photoanode in a static test reactor at various film thicknesses and sintering temperatures of the nanoporous Pt-doped TiO₂ film, whereby the Ti photoanode supports were dip-coated 3 or 5 times in a titania sol containing 1% platinum (Pt) and fired at 300° C. or 500° C., whereby the experiment was conducted in 100% fresh water (pH 7) with aeration, whereby the applied voltage was +1.0 V, and, whereby the data shown are mean±SEM (N=4).

FIG. 14 is a graph showing ammonia removal using the instant composite photoanode in aerated and non-aerated (i.e., static) test reactors containing 100% fresh water (pH 7) at various film thicknesses of nanoporous TiO₂, whereby the Ti photoanode supports were dip-coated 3 or 5 times in a titania sol and sintered at 500° C., and, whereby the applied voltage was +1.0 V (N=1).

FIG. 15 is a bar graph showing ammonia removal using the instant composite photoanode in a test reactor with stirring, air aeration, argon gas bubbling or static (control), whereby stirring was accomplished using a magnetic stir bar, whereby the uncoated Ti photoanode supports were dip-coated 3 times in a titania sol and sintered at 500° C., whereby the y-axis shows the concentration of ammonia (as N) remaining in solution after 3 minutes of reaction, whereby the experiment was conducted in 100% fresh water (pH 7), whereby the applied voltage was +1.0 V and N=1, and, whereby the y-axis is Ammonia Conc. (ppm as N).

FIG. 16 is a graph showing ammonia removal using uncoated Ti photoanode supports fired at 500° C. theoretically converting the Ti to a rutile polymorph in test reactors, whereby the initial ammonia concentration was 9 ppm ammonia as nitrogen, whereby the experiment was conducted in 100% seawater with aeration, whereby the applied voltage was +1.0 V, and, whereby the data shown are the results of 2 independent experiments.

FIG. 17 is a graph showing ammonia removal using uncoated Ti photoanode supports fired at 500° C. in test reactors, whereby the experiment was conducted in 100% seawater (Instant Ocean®) and freshwater containing 1 g/L NaCl, whereby both waters were aerated, whereby the applied voltage was +1.0 V, and, whereby the data shown are mean±SEM (N=3).

FIG. 18 is a graph showing ammonia removal using uncoated Ti photoanode supports fired at 500° C. in test reactors at various water pH values (pH 5 and pH 10) in test reactors, whereby the experiment was conducted in freshwater containing 1 g/L NaCl, whereby the water was aerated, whereby the applied voltage was +1.0 V, whereby the data shown are mean±SEM (N=3), whereby the pH was adjusted using sodium hydroxide or hydrochloric acid as needed, and, whereby controls were conducted with UV lights on, but no applied voltage.

FIG. 19 is a graph showing ammonia removal using uncoated Ti photoanode supports fired at 500° C. in test reactors at various applied voltages with respect to the reference electrode (WRT Reference), whereby the experiment was conducted in freshwater containing 1 g/L NaCl (pH 7), whereby water was aerated, whereby the applied voltage to the uncoated Ti photoanode support was 0, 0.3, 0.6, or 0.9 V WRT Reference, and, whereby the data shown are mean±SEM (N=3).

FIG. 20 is a bar graph showing nitrite and nitrate production using uncoated Ti photoanode supports fired at 500° C. in batch test reactors at various voltages applied between the uncoated Ti foil photoanode support and a silver wire reference, whereby the test solution consisted of 1.6 mg/L NH₄Cl in 1 g/L NaCl, whereby a potential difference of +1.0 V was maintained between the reference electrode and the photoanode, and whereby each point is an average of four replicate measurements.

FIG. 21 is a graph showing ammonia removal using the instant PECO device shown in FIGS. 1 and 2, whereby the experiment was conducted in freshwater containing 1 g/L NaCl (pH 7), whereby the water was aerated, whereby the applied voltage in the 2-electrode system was 2.2 V between the anode and cathode, whereby the applied voltage in the 3-electrode system was 1 V between the anode and reference electrode (2.2 V between the anode and cathode), and, whereby N=1.

FIG. 22 shows ammonia removal from water using the instant flow-through PECO device shown in FIGS. 1 and 2, whereby the experiment was conducted in 100% seawater, whereby the water volume was 7 liters (pH 7), whereby the water was aerated, whereby the applied voltage was +1 V, and whereby the data shown are results of two independent trials.

FIG. 23 is an electrical circuit diagram of the electrical components used in the instant invention, whereby the electrical circuit is a power supply that provides a user-selectable constant voltage and allows for a range of current (electrical load) varying between 0 and 500-1,000 mA, and whereby the circuit can be internally or externally driven by a computer-based or machine-based controller to allow for pulsing the voltage at a wave-form, frequency, and time (on/off) periods found to be optimal per the needs of an application.

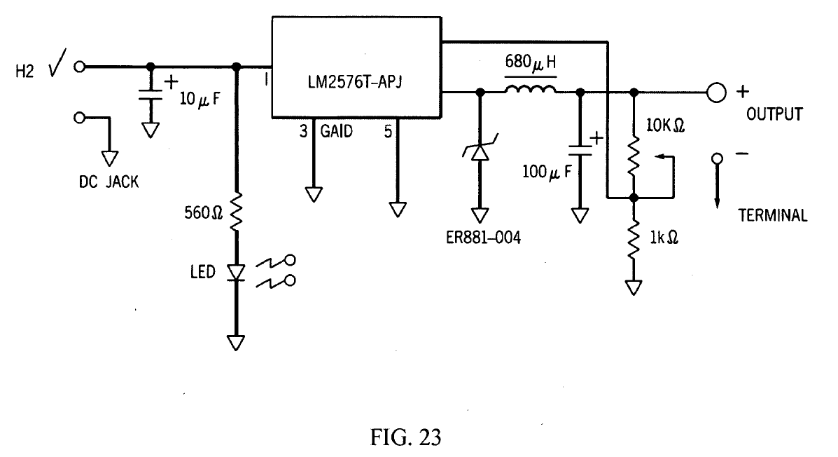

### DETAILED DESCRIPTION OF THE EXEMPLARY EMBODIMENTS

The instant invention will improve aquaculture production and increase export of U.S.-produced seafood products, particularly high value products that are difficult to produce in developing countries such as lobsters and carnivorous fish species. The instant invention will also expand recirculation aquaculture production, increase the efficiency of agricultural production, and expand economic opportunities. Growth of the U.S. aquaculture industry will expand economic opportunities in the rural U.S. New recirculation aquaculture facilities will begin supplying fish to large existing markets.

The instant invention will also reduce the number and severity of agriculture pest and disease outbreaks in aquaculture. The instant invention will ensure access to nutritious food. Supporting the development and expansion of the U.S. aquaculture industry will enhance the U.S. fish supply, which is a key component of a healthy diet. Growing demand for seafood products will also be satisfied by the instant invention. The instant invention will also protect watershed health to ensure clean and abundant water, and protect and enhance wildlife habitat to benefit desired, at-risk and declining species.

Fish are very susceptible to ammonia and nitrite toxicity. Ammonia concentrations as low as 0.025 mg/L (ppm) can kill some sensitive fish species. Some robust fish species may also die from exposure to ammonia concentrations as low as 0.2 to 0.5 mg/L. Nitrite concentrations as low as 0.1 mg/L can also kill some fish species. The temperature and pH of the water also influences fish morbidity and survival. (Randall D et al., 2002, Ammonia toxicity in fish, Mar. Pollut. Bull. 45:17-23).

In aqueous ammonia-containing solutions, NH₄⁺ ions are in equilibrium with non-ionized NH₃. The non-ionized form of ammonia, NH₃, is a potent neurotoxin to fish, and it readily diffuses across fish gill membranes. (Tomasso J, 1994, Toxicity of nitrogeneous wastes to aquaculture animals, Rev. Fish. Sci. 2:291-314). The pKₐ at equilibrium is 9.3, therefore, ammonia is more toxic to fish at higher pH values.

Nitrite is also highly toxic to fish. Nitrite levels as low as 0.1 mg/L can kill some fish specie. (Russo R et al., 1991, Toxicity of ammonia, nitrite and nitrate to fishes, Aquaculture and water quality, eds. E. Brune & J. Tomasso, pp. 58-89). By comparison, nitrate is considerably less toxic to fish than ammonia. However, nitrate can negatively impact fish health at levels around 40-50 mg/L. (Russo et al., 1991; and Ip Y et al., 2001, Ammonia toxicity, tolerance and excretion, Fish Physiology eds. P. Wright & P. Anderson, pp. 109-148, Academic Press, San Diego).

The instant PECO device oxidizes a significant and substantial portion of ammonia to nitrogen gas. The instant PECO device also oxidizes trace-level organic contaminants (e.g., endocrine disrupters, PBDEs), disease-causing microorganisms (e.g., Eschricia coli), and potential biological and chemical threat agents (e.g., G- and V-series nerve agents, brucellosis, ricin). Photoelectrocatalytic oxidation is very effective at destroying pathogens in water. Photoelectrocatalytic oxidation also reduces the incidence of disease outbreaks that occur in recirculation aquaculture systems and facilities.

Without being bound to any single theory, it is hypothesized that the instant PECO device including the composite photoanode performs photoelectrocatalytic oxidation according to the following reactions (also referred to as break point chlorination):

2Cl⁻→Cl₂+2e⁻ (I)

Cl₂+H₂O→HClO+Cl⁻+H⁺ (II)

2NH₄⁺+3HClO→N₂+3H₂O+5H⁺+3 Cl⁻ (III)

With the production of chlorine it is also possible for this process to produce chloroamine compounds. It would also be desirable to oxidize ammonium to nitrogen without the production of many other by-products. The instant PECO device allows for this possibility.

Without being bound to any single theory, it has been hypothesized that purely photocatalytic oxidation systems are effective because the process generates hydroxyl radicals. If hydroxyl radicals are also generated in the instant photoelectrocatalytic oxidation process, the generated hydroxyl radical is a general oxidizing agent, therefore, other contaminants (in addition to ammonia) will also be oxidized. In particular, dissolved organic species are oxidized to water, carbon dioxide, and halide ions during photoelectrocatalytic oxidation. Dissolved metals having suitable reduction potentials are reduced and deposited/adhered to the metal cathode.

In addition, the photoanode can also react with hydroxide ions (OH⁻) and produce OH radicals. The generated hydroxyl radical is a general oxidizing agent, therefore, other contaminants (in addition to ammonia) are also oxidized. In particular, dissolved organic species are oxidized to water, carbon dioxide, and halide ions during photoelectrocatalytic oxidation. Dissolved metals having suitable reduction potentials are reduced and deposited at the cathode.

One objective of the instant invention is to use photoelectrocatalysis as an ammonia treatment method for recirculating aquaculture systems. By controlling variables such as chloride concentration, light intensity, pH and applied potential, an irradiated and biased TiO₂ composite photoanode selectively oxidizes ammonia forming harmless nitrogen gas, whereby little or no other nitrogen compounds (e.g., nitrite) are formed as by-products.

The instant invention utilizes photoelectrocatalytic oxidation, whereby a photocatalytic composite photoanode is combined with a cathode to form an electrolytic cell. When the instant composite photoanode is illuminated by UV light, its surface becomes highly oxidative. Ammonia that comes into contact with the surface is converted primarily into nitrogen gas. Application of a potential to the composite photoanode provides further control over the oxidation products.

PECO is an elegant, efficient, and economical solution to the problem of nitrogenous waste removal from water. Nitrite and ammonia are rapidly oxidized by PECO, and PECO uses very little energy. (Sun C C et al., 1998, Kinetics and mechanism of photoelectrochemical oxidation of nitrite ion by using the rutile form of a TiO₂/Ti photoelectrode with high electric field enhancement, Industrial & Engineering Chemistry Research 37:4207-4214; and, Kaneko M et al., 2006). PECO also produces few, if any, secondary metabolites such as chlorine. The nanoporous electrodes used in the instant invention are cost effective to manufacture and operate.

The instant composite photoanode is constructed from a conductive metal electrode being a Ti foil support coated with a thin layer (200-500 nm, hypothetical) of a titanium dioxide (TiO₂) that functions as a photocatalyst. The TiO₂ photocatalyst is illuminated with light having sufficient near UV energy generating highly reactive electrons and holes promoting oxidation of compounds on the anode surface. (Candal R J et al., 1998, TiO₂-mediated photoelectrocatalytic purification of water, J. Adv. Oxidat. Technol. 3:270-276; Candal R J et al., 1999, Titanium-supported titania photoelectrodes made by sol-gel processes, J. Environmental Engineering 125:906-912; Candal R J et al., 2000, Effects of pH and applied potential on photocurrent and oxidation rate of saline solutions of formic acid in a photoelectrocatalytic reactor, Environ. Sci. Technol. 34:3443-3451).

After the titanium support was coated with a thin film of TiO₂, the composite electrode was air-heated at a high temperature. The nanoporous TiO₂ film has a crystalline structure due to thermal oxidation. It is believed that the instant titania, when heated at 500° C., converts to a crystalline rutile polymorph structure. It is further believed that the instant TiO₂ heated at 300° C. converts to a crystalline anatase polymorph structure. In some PECO applications, rutile TiO₂ has substantially higher catalytic activity than the anatase TiO₂. Rutile TiO₂ may also have substantially higher catalytic activity with respect to ammonia.

Exemplary photoanodes may be prepared by coating Ti metal foil being 15 cm×15 cm×0.050 mm thickness and 99.6+% pure from Goodfellow Corp., Oakdale, Pa., with a titania-based metal oxide. The Ti foil was cleaned with a detergent solution, rinsed with deionized water, rinsed with acetone, and heat-treated at 350° C. for 4 hours providing an annealed Ti foil. Annealing may also be conducted at higher temperatures such as 500° C.

Following that pretreatment, the metal foil was dip-coated three or five times with an aqueous suspension of titania at a withdrawal rate of ˜3.0 mm/sec. After each application of coating, the coated foil was air dried for 10-15 min and then dried in an oven at 70° C. or 100° C. for 45 min. After applying the final coating, the coated foil was sintered at 300° C., 400° C. or 500° C. for 4 hr at a 3° C./min ramp rate. Uncoated Ti metal foil was similarly heat-treated and fired at 500° C. The Ti foil may be dipped into suspensions of titania synthesized using methods disclosed in commonly-owned U.S. patent application Ser. Nos. 11/932,741 and 11/932,519, which are incorporated herein by reference. The optimized withdrawal speed is around 21.5 cm min⁻¹. Titanium foil was very stable, and can also be used to make active photoelectrodes.

Photocatalytic efficiency is significantly improved by applying a positive potential (i.e., bias) across the photoanode decreasing the recombination rate of photogenerated electrons and holes. The TiO₂ layer also significantly impacts the photoelectrocatalytic properties of the anode. Once TiO₂ is applied to the support structure, it is heated to a high temperature producing a crystalline structure via thermal oxidation. It is hypothesized that titanium heated at 500° C. has a rutile crystal polymorph structure. Titanium heated at lower temperatures (e.g., 300° C.) has an anatase polymorph structure. In one photoelectrocatalytic application, it has been reported that rutile films demonstrate significantly higher catalytic activity than anatase films. (Candal et al., 1999).

In particular, dissolved organic species are oxidized to water, carbon dioxide (CO₂), and halide ions (e.g., Cl⁻) during PECO. Dissolved metals having appropriate reduction potentials are reduced and deposited on the metal cathode. Several operating parameters influence these reactions, such as current density, pH, chloride concentration, and the presence of other anions such as SO₄²⁻, PO₄³⁻, NO₃⁻— and CO₃²⁻.

The instant PECO device also removes proteins from aquarium or aquaculture water. Dissolved organics (including proteins) can accumulate in water and degrade water quality. Most salt water aquaria are equipped with a protein skimmer for removing dissolved organics and proteins. Such organic material often has a yellowish tint and is sometimes called “gelbstoff” (German for yellow stuff). The PECO device was used for 45 mins to treat water spiked with a known concentration of protein being bovine serum albumin. No protein remained in the treated water.

In another experiment, water was spiked with gelbstoff collected from a saltwater aquarium. Using the instant PECO device, the gelbstoff was completely oxidized upon treatment overnight. The treated water was free of gelbstoff and perfectly clear as measured using a wavelength of 600 nm in a microplate spectrophotometer. Protein concentrations fell from over 25 ug/ml to 0 in the same time.

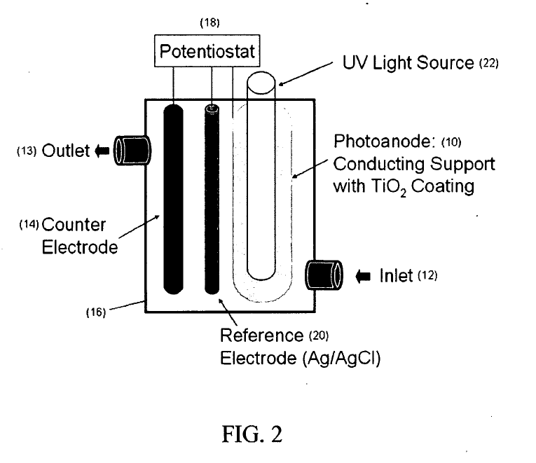

An exemplary configuration of the flow-through PECO device of the present invention is shown in FIG. 2. The cylindrical flow-through configuration includes a composite photoelectrocatalytic photoanode 10 and a corresponding cathode 14. The photoanode 10 and cathode 14 are house within a housing 16. The housing 16 includes a water inlet 12 and outlet 13. An electrical potential is applied across the cathode 14, composite photoanode 10 by an electrical power source and potentiostat 18. A reference electrode 20 is in electrical communication with the potentiostat 18. A UV light source 22 illuminates the composite photoanode 10. In the instant device, the TiO₂ catalyst layer of the composite photoanode 10 strongly adheres to the Ti electrode and does not disperse into the solution. So, no need exists for a module to separate the catalyst from the treated solution and/or to return the catalyst to the contaminated water. In addition, because the hydroxyl radical as well as Cl₂ are general oxidizing agents, other contaminants (besides ammonia) are oxidized. The instant PECO device is capable of completely degrading contaminants in a single pass. Water flow rate is also an important design parameter.

In an exemplary embodiment, the potential on the composite photoanode 10 is held constant relative to a saturated calomel reference electrode by the potentiostat 18, such as that available from EG&G, Model 6310. The potentiostat 18 is connected to the reference electrode through a semi-micro saline bridge, such as available from EG&G, Model K0065. The saline bridge may be disposed inside the reactor close to the composite photoanode 10. The current passing through the PECO device may be measured.

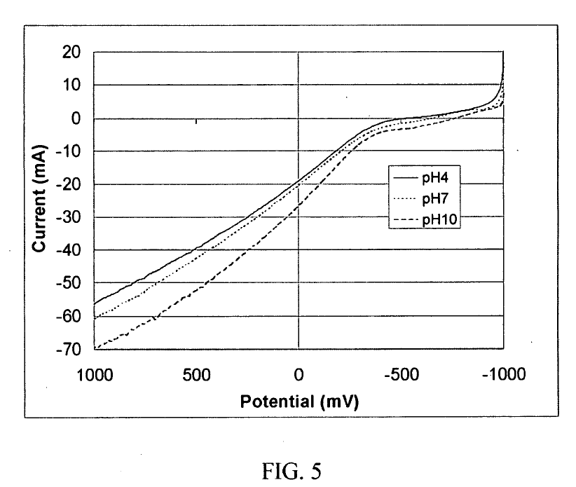

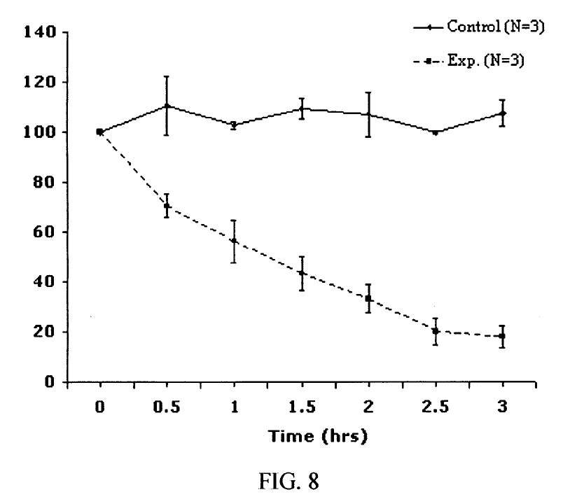

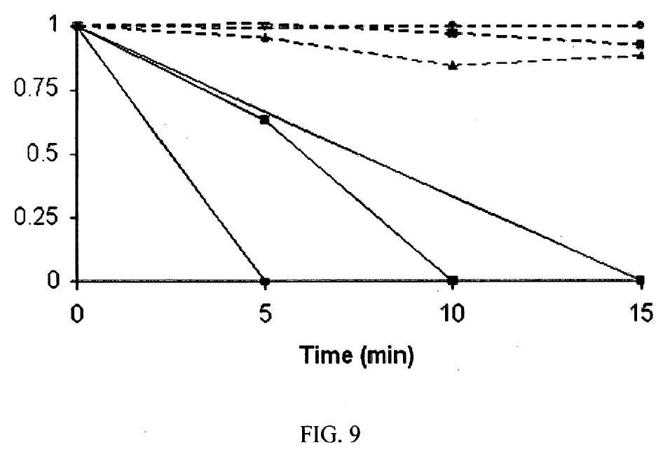

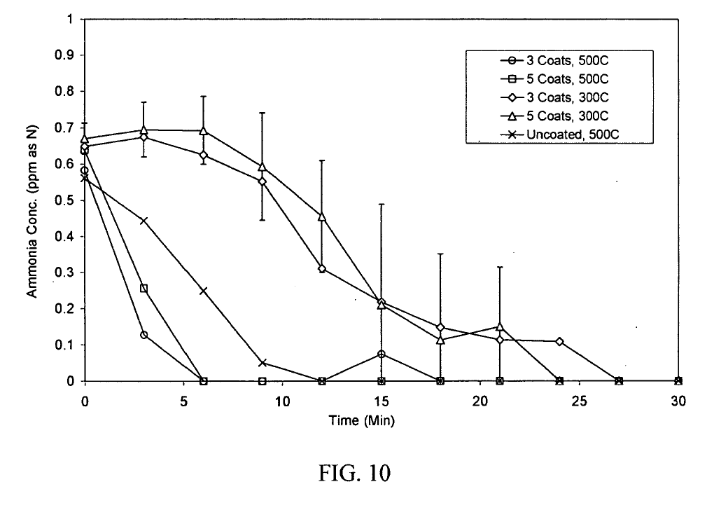

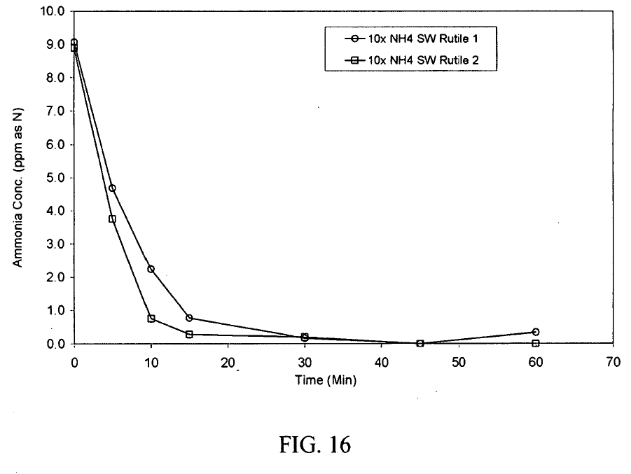

The EG&G potentiostat was used to obtain data shown in FIGS. 5-9. Data shown in FIGS. 10-22 were obtained using a Princeton Applied Research Model VMP2/Z-01 Electrochemical Analyzer. The saline bridge was used with the EG&G system. A silver wire reference electrode was also used.

The instant potentiostat is a variable current source that can measure a voltage between two electrodes. The potentiostat can perform a wide variety of electrochemical functions, but the two exemplary functional modes are constant current and constant voltage. In constant current mode, the potentiostat supplies a user specified current to the electrodes. In constant voltage mode, it supplies current to the electrodes while monitoring the voltage. It can then continually adjust the current such that the voltage will remain constant at a user specified value. A potentiostat can also be configured to supply pulses.

During operation of the instant PECO device, ammonia steadily disappeared from the water as determined by the assay limits in approximately 2.5 hrs. Zero to trace amounts of nitrite and nitrate were present in the 3 hr samples, which indicates that ammonia was converted to nitrogen gas. The reaction was substantially faster in seawater (35 ppt Instant Ocean®), whereby ammonia completely disappeared at 1.5 hrs. The faster reaction kinetics in seawater may be due to break point chlorination because of the presence of chloride ions leading to photoelectrocatalytic oxidation production of Cl₂, HOCl, and OCl⁻ oxidizing specie in the seawater. Faster kinetics may also be due to the freer flow of electrons in the saline water.

As shown in FIG. 5, at pH 4, pH 7 and pH 10, the photoanode generated an anodic current at applied potentials greater than −0.55 V. Thus, TiO₂ has a flat band potential less than zero. As the pH of the solution increased from 4 to 7 to 10, the potential that generated an anodic current changed from −0.55 V to −0.65 V to −0.76 V. This is an average change of 33 to 38 mV per pH unit rather than the expected 59 mV per pH unit, which may have been due to the electrolyte not fully equilibrating with the photoanode surface prior to the start of an experiment.

Any temperature of liquid water is suitable for use with the instant PECO device. Preferably, the water is sufficiently low in turbidity to permit sufficient UV light to illuminate the composite photoanode.

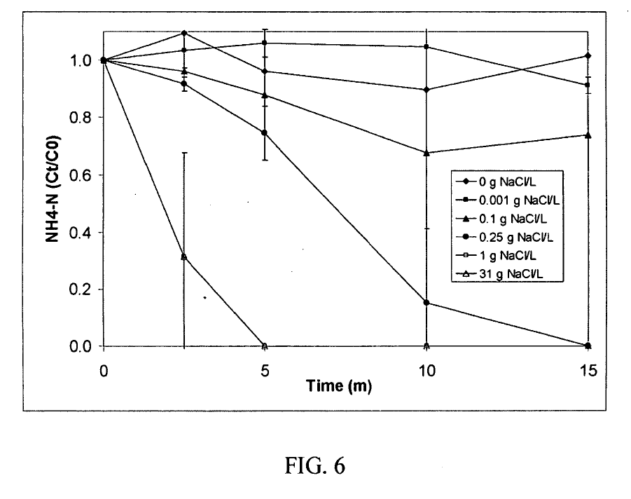

As shown in FIG. 6, in a NaCl electrolyte of 0 g/L, no ammonia was removed. The NaCl solution at 0.25 g/L showed total ammonia removal in 15 minutes. Ammonia in a NaCl solution of 1 g/L was completely removed in 5 minutes, and, ammonia was completely removed in 2.5 minutes when the NaCl concentration was increased to 31 g/L. 31 g NaCl/L is particularly useful for saltwater aquaculture systems, as this is the chloride equivalent found in natural seawater (i.e., Cl⁻ concentration ˜19 g/L). Thus, chloride concentration affects the ammonia removal rate. Since no ammonia removal was observed in the absence of chloride, ammonia may have been oxidized directly by the photoelectrochemical production of chlorine.

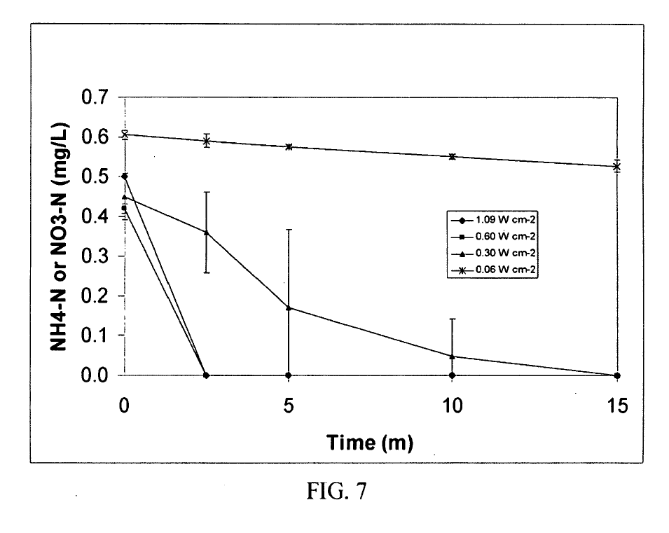

As shown in FIG. 7, four intensities of light were tested to compare NH₄⁺/NH₃ removal and resultant NO₃⁻ and NO₂⁻ production: 1.09, 0.60, 0.30, and 0.06 W/cm². Each level of intensity showed comparable distribution of wavelengths of light ranging from 200-900 nm. At 0.06 W/cm², 13% of initial ammonia was removed in fifteen minutes with no NO₃⁻ or NO₂⁻ produced. At 0.3 W/cm², total ammonia removal was observed in 15 minutes with 9% of the ammonia-nitrogen converted to NO₂⁻, and 4% converted to NO₃⁻. At 0.6 W/cm², total ammonia removal was observed in 15 minutes, with 3% of the ammonia-nitrogen converted to NO₂⁻, and 3% converted to NO₃⁻. At 1 W/cm², total ammonia removal was observed in 15 minutes, with 1% of the ammonia-nitrogen converted to NO₂⁻, and 13% converted to NO₃⁻. Ammonia removal and resultant nitrogen species depend on light intensity.

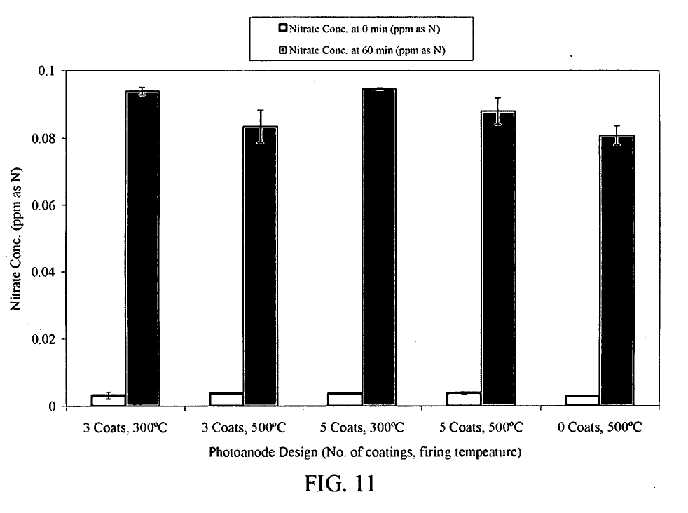

As shown in FIGS. 10 and 11, composite photoanodes prepared by sintering the TiO₂ film at 500° C. removed ammonia from water significantly faster than composite photoanodes fired at 300° C. Composite photoanodes prepared by applying three coatings of TiO₂ did not perform significantly better than photoanodes prepared by applying five coatings of TiO₂. As shown in FIG. 10, uncoated Ti foil supports fired at 500° C. demonstrated faster ammonia removal than coated Ti foil supports fired at 300° C. Similar reaction kinetics were observed for composite photoanodes coated with nanoparticulate TiO₂ and sintered at 500° C. suggesting that a thin, highly catalytic, nanoporous TiO₂ film forms on the surface of uncoated Ti when it is heated to 500° C. As shown in FIG. 11, no nitrite and very little nitrate (<16% of ammonia nitrogen was found as nitrate nitrogen) were formed during the incubations suggesting that the majority of the ammonia was oxidized into nitrogen gas.

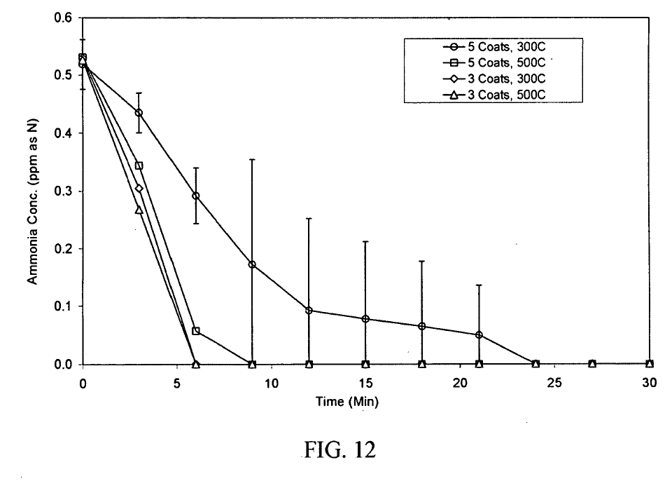

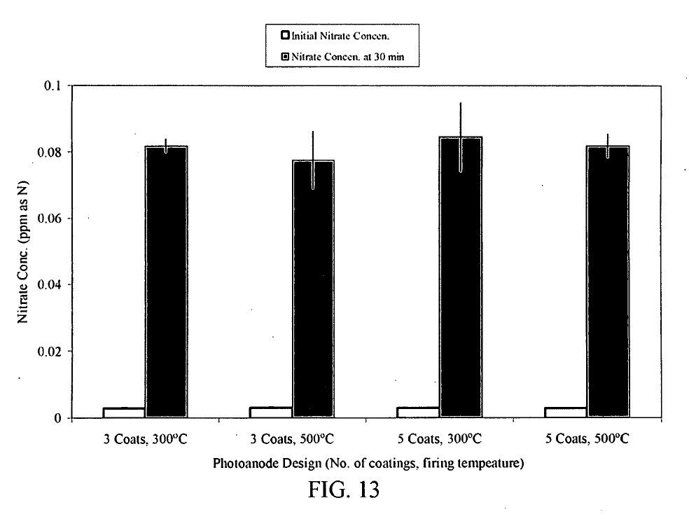

As shown in FIGS. 12 and 13, composite photoanodes having a Ti foil support and a thin-film of TiO₂ doped with Pt and sintered at 300° C. removed ammonia from solution slightly better than undoped TiO₂ coatings sintered at the same temperature. There was an insignificant difference in ammonia removal between undoped and Pt-doped TiO₂ coatings sintered at 500° C. There was also an insignificant difference between platinized and non-platinized photoanodes in terms of the amount of nitrate formed. Approximately 15% of the original nitrogen as ammonia was converted into nitrogen as nitrate on average. Thus, the data suggest that there is no advantage of using Pt-doped TiO₂ thin films over pure TiO₂ films for converting aqueous ammonia into nitrogen gas in the instant PECO device. The Pt may have functioned as an electron sink in the photocatalytic reactions, which may be unnecessary when a bias (voltage) is applied to the catalyst to pull off photogenerated electrons. Thus, the addition of Pt to the instant anodes would be an unnecessary additional expense in the instant PECO device.

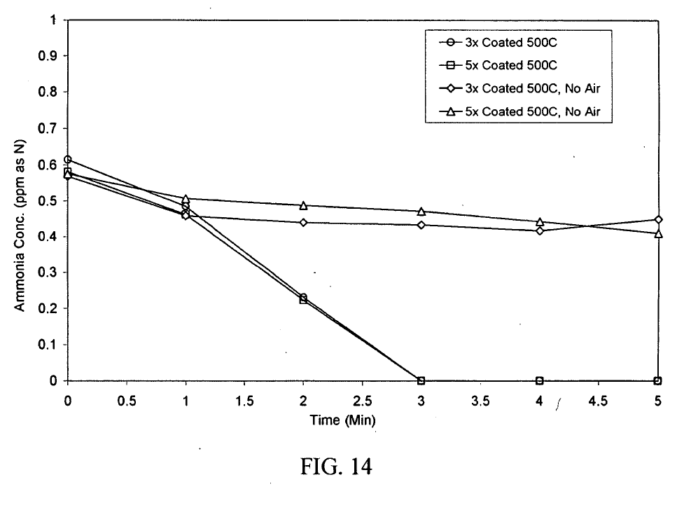

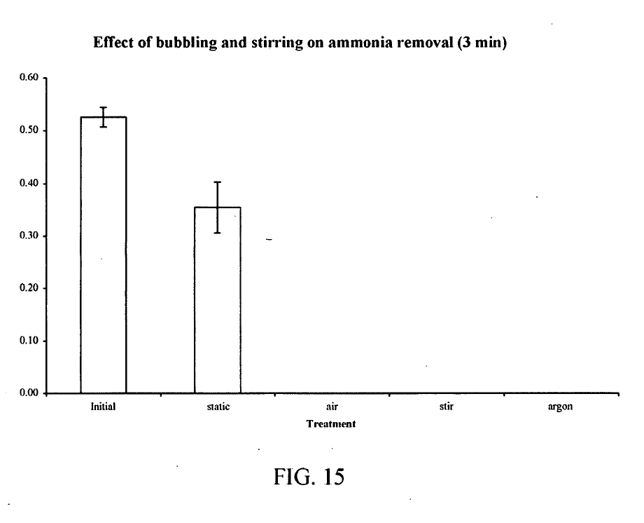

As shown in FIGS. 14 and 15, bubbling air into the static incubation test reactors was advantageous for rapid ammonia removal. An experiment was conducted to determine the mechanism of this aeration effect. Without being bound to any theory, it may be hypothesized as follows: (1) aeration disrupts a boundary layer that prevents ammonia from reaching the anode surface, and (2) aeration provides oxygen required for the reaction to occur, whereby oxygen is a likely final electron acceptor in the redox reactions occurring in the experiment.

There were four treatment groups: static control (no air, no stirring), water mixed with a magnetic stir bar, aeration with air, and, aeration with argon gas (no oxygen present in the system). The results show efficient ammonia removal with stirring, air aeration, and argon aeration indicating that such mixing facilitates the reaction supporting hypothesis 1. The result also suggests that ammonia removal in the instant PECO flow-through device would not be limited by the presence of boundary layers when there is sufficient flow, preferably turbulent flow, through the device.

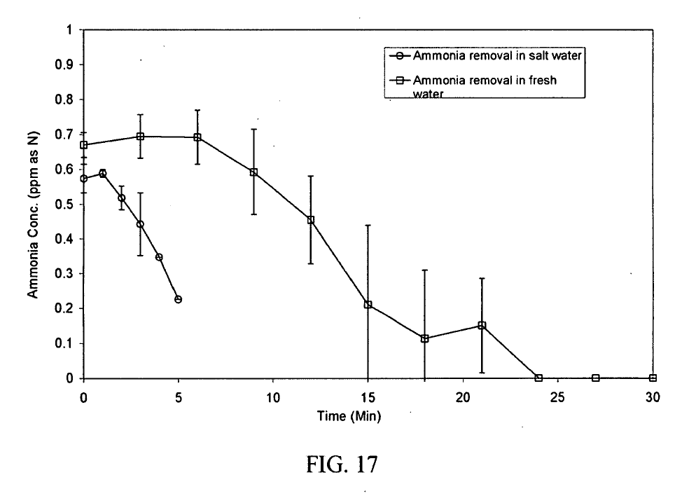

As shown in FIG. 17, ammonia removal was significantly faster in 100% seawater (40.5 g/L Instant Ocean®) compared to freshwater containing 1 g/L NaCl. The data also suggest that some chloride must be present in the water for the reaction to proceed. One possible explanation is that chloride ions are required for the silver reference electrode to form a silver/silver chloride half-cell maintaining a proper voltage between the anode and cathode. Another possible explanation is that (under photoelectrocatalytic oxidation) ammonia is not directly oxidized on the anode surface. Instead, ammonia may be oxidized by reactive hypochlorite generated in situ.

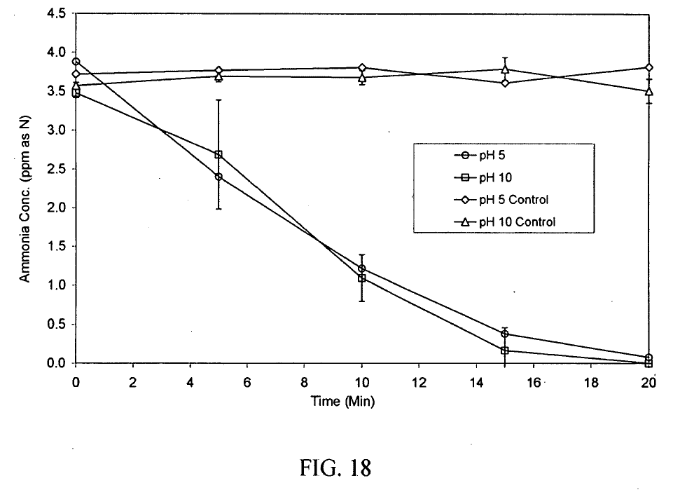

As shown in FIG. 18, ammonia removal rates were identical in water at pH 5 and pH 10 suggesting that oxidation of ammonia is independent of pH over the range of pH values useable in almost all aquaculture applications. The results also indicate that pH does not play a significant role in regulating the oxidation of aqueous ammonia. In aqueous solution, ammonia exists in equilibrium between the ionized (NH₄⁺) and the non-ionized form (NH₃) having equilibrium pKₐ 9.3. Therefore, approximately 85% of the ammonia was in the NH₃ form at pH 10, and essentially 100% in the NH₄⁺ form at pH 5. There was a possibility that the positively charged NH₄⁺ molecule might not have been oxidized as efficiently as the neutral NH₃ species because it would have been repelled by the positive bias on the photoanode surface, however, that did not occur. Ammonia oxidation may not have occurred directly upon the anode surface. Instead, ammonia may have been oxidized by a soluble reactive intermediary such as hypochlorite.

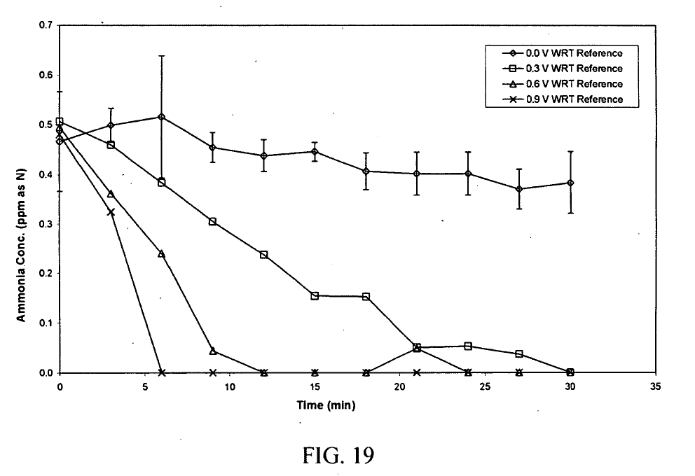

In other experiments, a potential of 1 V was shown to be highly effective. As shown in FIG. 19, four other applied voltages were tested being 0.0, 0.3, 0.6, and 0.9 V. Lower voltages may also be as effective as higher voltages. Commercial-scale devices are more cost-effective to operate at lower voltages. At voltages higher than ˜1.2 V DC between the anode and cathode, water electrolysis occurs, whereby water molecules break apart forming hydrogen gas (H₂) and oxygen gas (O₂). However, applied pulsed voltages greater than 1.2 V may be beneficial. Pulsing the applied voltage may minimize water electrolysis and increase ammonia oxidation efficiency.

No ammonia removal was observed without an applied bias. Ammonia removal was greater at higher voltages probably because more electrons were carried away maintaining a greater oxidative photoanode surface. Significant hydrogen gas production at the cathode was also observed indicating water electrolysis forming H₂ and O₂. Electrolysis of water occurs at voltages higher than 1.2 V, which was exceeded at all voltages tested because (with the Ag wire reference electrode) a voltage of 0 between the reference electrode and anode translates to a voltage of approximately 1.2 V between the anode and cathode. Pulsing of the applied voltage may minimize water electrolysis.

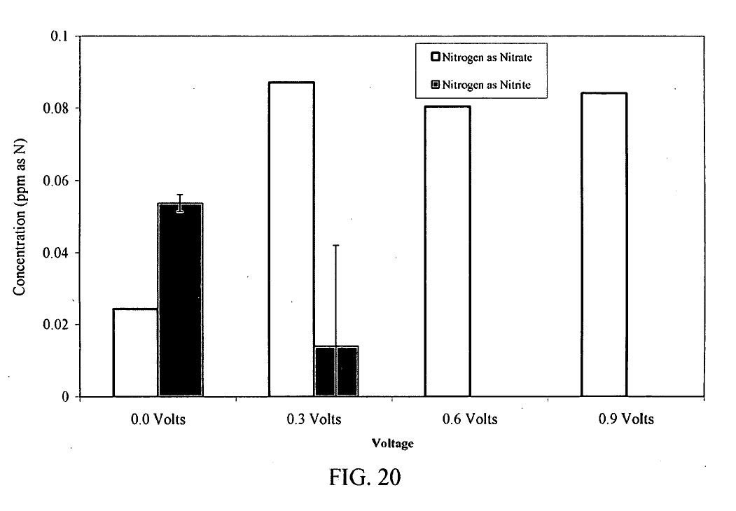

FIG. 20 shows the effect of applied voltage on nitrate removal. The results indicate that increasing the operating voltage increases the rate of formation of nitrate until a plateau is reached around 0.3 V. The instant PECO device minimizes the formation of nitrite suggesting that the applied voltage is preferably at least +0.6 V.

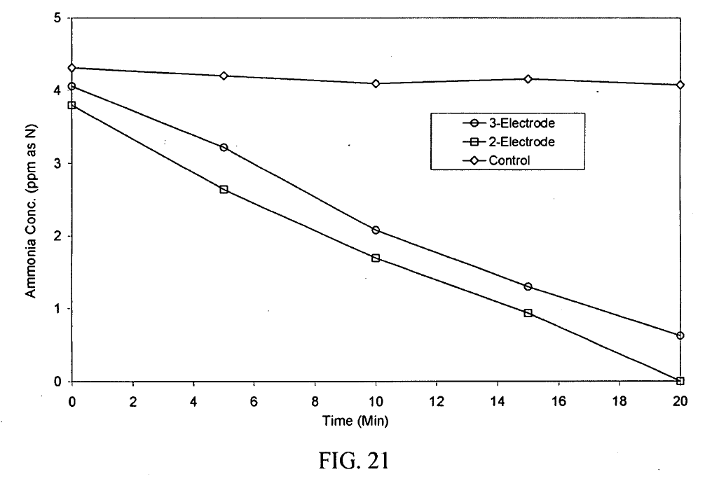

A 3-electrode system would be more expensive under aquaculture conditions. Efficacy of a 2-electrode configuration was tested. A 2-electrode PECO device was tested at 2.2 V applied between the photoanode and cathode, which corresponds to the same voltage between the anode and cathode in the 3-electrode configuration (i.e., 1.2 V half-cell +1 V). As shown in FIG. 21, ammonia removal rates were essentially the same for the 2- and 3-electrode units.

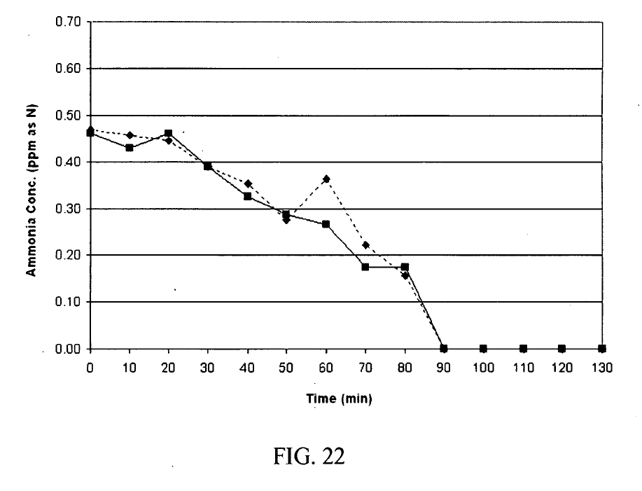

As shown in FIG. 22, there was complete ammonia removal from seawater initially spiked with ˜0.7 ppm ammonia-nitrogen in 90 minutes using the flow-through reactor rather than the static reactors employed for the earlier tests discussed above. Commercial applications on the instant invention may use flow-through reactors where variables such as water flow rates through the device (i.e., photocatalyst contact time) determines reaction efficiency.

The amount and type of dissolved ions can affect the photocatalytic reaction rate, which is important to consider in designing a PECO unit for treating ammonia in saltwater systems. The potential for generating chlorine in seawater is an operating concern for PECO. It is important to understand the effect of operating voltage on the chlorine generation rate as compared to the ammonia degradation rate in seawater systems. Thus, the voltage is to be optimized to minimize chlorine generation while providing a suitable ammonia conversion rate. If ammonia removal occurs by breakpoint chlorination as hypothesized (see reactions I-III above), an exemplary device would generate only enough chlorine to react with the ammonia being generated so that no chlorine would remain to be sent back to the tank. Such a system would require effective real-time sensors for both chlorine and ammonia. A conventional activated carbon filter may be employed to absorb and filter chlorine from the aquarium or aquaculture water.

Alkaline buffers, such as sodium and potassium bicarbonate, and sodium and potassium hydroxide, may be employed to stabilize pH without significantly interfering with efficient operation of the instant PECO device. Various processes occur during photocatalytic and photoelectrocatalytic oxidation that can affect the pH of the water being treated. Any changes in the pH during treatment can alter the reaction kinetics. So, for aquaculture applications, pH is monitored to protect fish health. The ΔpH is relatively small at low initial ammonia concentrations.

Other control conditions may also be optimized. For example, the lights may be active while the electrical potential is inactive, or the electrical potential may be active while the lights are inactive.

Various UV light sources, such as germicidal UVC wavelengths (peak at 254 nm) and black-light UVA wavelengths (UVA range of 300-400 nm), may also be employed. For the instant composite photoanodes, the optimal light wavelength for driving photoelectrocatalytic oxidization is 305 nm. However, various near-UV wavelengths are also highly effective. Both types of lamps emit radiation at wavelengths that activate photoelectrocatalysis. The germicidal UV and black light lamps are widely available and may be used in commercial applications of the instant PECO device.

The intensity (i.e., irradiance) of UV light at the photoanode may be measured using a photometer available from International Light Inc., Model IL 1400A, Super-Slim probe. An exemplary irradiation is greater than 3 m Wcm⁻².

UV lamps also have a “burn-in” period. UV lamps have a limited life in the range of approximately 6,000 to 10,000 hours. UV lamps also typically lose 10 to 40% of their initial lamp irradiance over the lifetime of the lamp. Thus, it is important to consider the effectiveness of new and old UV lamps having >5,000 hrs burn-in period lamps in designing and maintaining oxidation of ammonia.

### EXAMPLES

### Example 1

Static test system. The photoanode was rolled into the cylinder and disposed into a 300 ml glass beaker. The UV light source contained in a quartz sleeve (32 mm ID, 35 mm OD, 15 cm long) was disposed in the center of the beaker. The cathode (which was the counter electrode) comprised a Ti wire (0.5 mm diameter and 15 cm long from Goodfellow Corp., Oakdale, Pa.). The reference electrode comprised a silver wire (0.5 mm diameter and 15 cm long from Goodfellow Corp., Oakdale, Pa.).

The cathode and reference electrodes were attached to the outer wall of the quartz sleeve with silicon glue running parallel and separated by 2 cm. The light source was a 9-watt, low-pressure mercury vapor lamp (Jebo Corp., Taiwan, China) that emitted ultraviolet germicidal irradiation (UVGI) at a primary wavelength of 254 nm. The distance from the light to the photoanode was approximately 5 cm. Four identical static PECO systems were prepared for replicate testing.

Each experiment, except the 2-electrode experiment, were performed using a 3-electrode configuration being a photoanode, a cathode, and a reference electrode. In 3-electrode configuration, a potentiostat controlled the voltage applied to the photoanode with respect to a reference electrode. A silver wire was used as the reference electrode, which functioned as a Ag/AgCl half cell in water containing chloride ions. Where relevant, voltages are reported with respect to the silver wire reference. In the 3-electrode configuration, the actual voltage between the photoanode and the cathode 1.2 V higher than the reported voltage.

Experiment procedure. The beakers were filled with 250 ml of either 100% seawater (made using 40.5 g/L of Instant Oceans from Spectrum Brands, Inc., Madison, Wis.) or freshwater containing 1 g/L NaCl. Each water was spiked with ammonium chloride to provide the ammonia source (0.5 to ˜10 mg/L initial concentration). The wetted area of each photoanode was approximately 180 cm². In several experiments, air was bubbled into each beaker providing aeration and assuring uniform mixing of the water during the experiments using a small aquarium diaphragm air pump. Each experiment was conducted at room temperature (22° C.±2C.°).

The electrodes were connected to a Model VMP2 multi-channel potentiostat from Princeton Applied Research, Oak Ridge, Tenn. During operation, a constant voltage was applied between the photoanode (the working electrode) and the reference electrode. The potentiostat was controlled (and the data on voltage and current were recorded) using EC-Lab V.92 software from Princeton Applied Research, Oak Ridge, Tenn. Experiments were started by simultaneously turning on both the UV lights and applied voltage.

At set intervals every 2-5 minutes, 1-ml samples of water were collected from each beaker and the ammonia concentrations were measured. Samples were collected in 1.5 ml microcentrifuge tubes and measured within 1 hr or stored at 4° C. for later measurement. No change was observed in ammonia or nitrate concentrations for up to one week of storage.

Larger samples (˜10 ml) were collected at the end of each experiment to measure nitrite and nitrate concentrations. These samples were stored at 4° C. for later measurement. Experiments lasted several minutes or 1-4 hr. 100% ammonia removal and duration depended upon the experimental conditions being evaluated. Ammonia removal required both UV light and applied voltage. Controlled incubations also included devices having light and no applied voltage.

Ammonia concentrations were measured using the indophenol method (Tetra kits) modified for use with a microtitre plate spectrophotometer. Ammonia test reagents were obtained from Tetra of Blacksburg, W. Va. Nitrite and nitrate concentrations were measured using ion chromatography from Dionex of Sunnyvale, Calif.

Flow-through PECO test device. A flow-through PECO device was fabricated by modifying a commercially available 9-watt UV sterilizer from Jebo Corp., Taiwan, China. Regarding the device components for the static system, a titanium wire was spot-welded to the back of the photoanode providing an electrical connection. The device was connected to a 7-liter aquarium and water was pumped through the system with an aquarium power head at constant flow rate of 2 gallons per hour. As with the static experiments, water samples were collected at regular intervals and ammonia concentrations were measured calorimetrically.

### Example 2

Chemicals. TiO₂ coatings on photoanodes were made from titanium isopropoxide (Aldrich Chemical, 97%) and nitric acid (Aldrich Chemical, American Chemical Society reagent grade). NH₄Cl and NaCl were obtained from Fisher Scientific (Fairlawn, N.J.). NaNO₃ and NaNO₂ standards were obtained from SPEX Certiprep (Metuchen, N.J.). NH₄⁺/NH₃ was measured using commercial kit reagents for indophenol method. All chemicals were used without further purification. All solutions were prepared with ultrapure water (18.1 MΩcm) from a NANOpure UV system (model 07331, Bamstead/Thermolyne, Dubuque, IA).

Composite Photoanode Preparation. The photoanode substrate material was annealed titanium foil 0.05 mm thick (99.6+% purity, Goodfellow Cambridge Ltd). Foils were cut to size for the experimental cell and pre-heated to remove organic contaminants by firing for 300° C. for 3 h. Suspensions of titanium dioxide were prepared using processing methods. (See Candal et al., 1998). Photoanodes were dip-coated into the TiO₂ suspension to achieve homogenous coatings of TiO₂ on titanium metal support. Two additional dip-coatings were applied, and the resulting materials were fired at 400° C. for 3 h to sinter the TiO₂ coating to the Ti support.

Experimental Setup. The reaction vessel was a rectangular Teflon block measuring 15.6 cm high and 7.8×8 cm, and having a single cylindrical cavity measuring 5.1 cm in diameter providing a single-compartment cell. A 4.3 cm diameter hole was cut through one side of the cell and covered with a quartz window. Light was passed through the window to irradiate the photoanode. Light was generated by a 500 W Oriel brand Hg(Xe) lamp (Lamp Housing Model No. 66021, Power Supply Model 8540, Lamp Model No. 66142, Newport Stratford, Conn.). Light was measured with an International Light IL 1700 research photometer with a SED033/QNDS2W/detector. Distribution of wavelengths (200-900 nm) was measured by an Ocean Optics USB2000™ probe and OOI Base31™ software, version 2.0.1.4.

To prevent heating of the electrolyte, infrared radiation was absorbed by a water filter. Electrolyte was mixed by a stir bar and magnetic stir plate. Compressed air was slowly bubbled into solution. There was no observed loss of electrolyte volume during the fifteen experiments. The cell was left unsealed and exposed to room air. Each experiment employed a saturated calomel electrode (SCE) with a Vycor™ frit and a bridge tube filled with 3M KCl filling solution (Princeton Applied Research-Ametek, Oak Ridge, Tenn.).

Ammonia solution was freshly prepared before each experiment. The pH of the solution was adjusted with 0.1M NaOH and/or 0.1M H₂SO₄. During each experiment, 1.3mL samples were periodically withdrawn for NH₄⁺/NH₃ measurement. For the determination of NO₂⁻ and NO₃⁻, 1.3 mL samples were taken at the start and end of every experiment. With the exception of the flow-through experiments, all samples were taken from the solution in the cell, from the irradiated side of the photoanode, and drawn from the top of the solution using a 1-5 mL pipette with disposable pipette tips. For experiments using the flow-through set-up, samples were taken from the 4 L reservoir. All samples were stored at 4° C. until analyzed. To control the potential during these studies, and to measure the photocurrent generated, an electrochemical impedance analyzer was used (Princeton Applied Research-Ametek, Oak Ridge, Tenn.) along with PerkinElmer™ Model 250 Research Electrochemistry Software (PerkinElmer, Waltham, Mass.).

Analytical Methods. The pH was measured using pH electrode (model 8272BN; Thermo Orion, Beverly, Mass.) and model 370 Thermo Orion pH meter (Thermo Orion, Beverly, Mass.). Ammonia was measured by the phenate method (APHA-AWWA-WPCE, 1985), using a spectrophotometer (λ=600 nm) with a 96-well microplate autoreader (model EL311, BioTek Instruments, Winooski, Vt.). Results were analyzed with DeltaSoft3 version 2.26 software (Hillsborough, N.J.).

NO₃⁻ and NO₂⁻ concentrations were measured using a Dionex ion chromatograph (IC) with an Ion Pac AG9-HC guard column (4×50 mm), and an Ion Pac AS9-HC analytical column (4×250 mm) connected to an ED 50 conductivity detector. An AS 40 autosampler and GP 50 gradient pump were also used, with a sample loop volume of 200 μL.

NO₃⁻ and NO₂⁻ levels were calculated using a five-point calibration curve. NH₄⁺/NH₃ was measured using a six-point calibration curve. Both measurements used external standards, with a blank sample and/or internal standard re-checked every 20 samples. Samples were run in duplicate with duplicates differing from one another less than 5%.

For all concentrations of NaCl tested, less than 4% of the ammonia was converted to NO₂⁻. (See Table 1). NO₃⁻ formation depended on NaCl concentration, whereby the following relationship between NaCl concentration and percentage of NO₃⁻ formed was observed: NaCl at 0 g/L→5% NO₃⁻ formed; NaCl at 0.001 g/L→1% NO₃⁻ formed; NaCl at 0.1 g/L→26% NO₃⁻ formed; NaCl at 0.25 g/L→41% NO₃⁻ formed; NaCl at 1 g/L→40% NO₃⁻ formed; and, NaCl at 31 g/L→13% NO₃⁻ formed. (See Table 1).

Table 1. Ammonia-nitrogen removal and product yields at different chloride concentrations: 0, 0.001, 0.1, 0.25, 1, and 31 g NaCl/L. Initial concentration NH₄+0.54 mg/L; initial pH 7; reaction time 15 mins; applied potential +1.0 V vs SCE, TiO₂-coated Ti photoanode irradiated with full spectrum light intensity 1.09 W/cm².

TABLE 1

| NaCl | % NH₄⁺ | % NO₂⁻ | % NO₃⁻ | % mass |
|---|---|---|---|---|
| (g/L) | remaining | yield^{a} | yield^{b} | recovery^{c} |
| 0 | 102 | 4 | 5 | 111 |
| 0.001 | 91 | BDL^{d} | 1 | 92 |
| 0.1 | 74 | BDL^{d} | 26 | 100 |
| 0.25 | BDL^{d} | 3 | 41 | 44 |
| 1 | BDL^{d} | 3 | 40 | 43 |
| 31 | BDL^{d} | BDL^{d} | 3 | 13 |

^{a}[NO₂⁻]t/[NH₃]T, 0 × 100.
^{b}[NO₃⁻]t/[NH₃]T, 0 × 100.
^{c}([NO₂⁻]ₜ₁₅ + [NO₃⁻]ₜ₁₅ + [NH₄⁺]ₜ₁₅)/[NH₄⁺]ₜ₀ × 100.
^{d}Below detection limits.
^{e}Below detection limits.

Table 2. Ammonia removal and product yields at different light intensities: 1.09, 0.60, 0.30, and 0.06 W/cm². Initial concentration NH₄+0.54 mg/L; initial pH 7; reaction time 15 mins; applied potential +1.0 V vs SCE, TiO₂-coated Ti photoanode irradiated with full spectrum light.

TABLE 2

| Light | | % | | |
|---|---|---|---|---|
| Intensity | % NH₄⁺ | NO₂⁻ | % NO₃⁻ | % mass |
| (W/cm²) | remaining | yield^{a} | yield^{b} | recovery^{c} |
| 0.064 | 87 | BDL^{d} | BDL^{d} | 87 |
| 0.3 | BDL^{d} | 9 | 4 | 13 |
| 0.6 | BDL^{d} | 3 | 3 | 6 |
| 1 | BDL^{d} | 1 | 13 | 14 |

^{a}[NO₂⁻]t/[NH₃]T, 0 × 100.
^{b}[NO₃⁻]t/[NH₃]T, 0 × 100.
^{c}([NO₂⁻]ₜ₁₅ + [NO₃⁻]ₜ₁₅ + [NH₄⁺]ₜ₁₅)/[NH₄⁺]ₜ₀ × 100.
^{d}Below detection limits.

### Example 3

Fifteen minute chronoamperometry experiments were conducted to analyze the effects of salinity, light intensity, and applied potential on the photoelectrocatalytic oxidation of aqueous NH₄⁺/NH₃. TiO₂ coatings were applied to Ti foil by dip coating and sintered at 400° C. to sinter a nanoporous photocatalytic surface. Photoanodes were used in combination with a platinum wire counter electrode and saturated calomel reference electrode (SCE) to test ammonia removal and nitrate/nitrite production at initial ammonium/ammonia concentration 0.54 mg NH₄⁺/L, initial pH 7 in a well-mixed static reactor with compressed air sparged into solution. At applied potentials greater than −0.4 V, NH₄⁺ was totally removed in ten minutes and less than 3% of the initial NH₄⁺ was converted to NO₃⁻ and none was converted to NO₂⁻.

Chloride ions are present at 0.25 g NaCl/L or greater so that ammonia oxidation occurs. Conversion of NH₄⁺ and NO₃ to N₂ reached 40-41% at lower salinities, but at 31 g NaCl/L, only 3% of NH₄⁺—N was converted to NO₃⁻ N. No more than 4% of NH₄⁺—N was converted to NO₂N for any salinity tested. At least 0.3 W/cm² is applied for NH₄⁺ oxidation, and 9% or less of the initial NH₄⁺—N formed NO₃⁻ N or NO₂—N.

We claim:

1. A photoelectrocatalytic oxidation device for use in an aquarium or aquaculture comprising:
a photoelectrocatalytic composite photoanode comprising a solid nanoporous film member having a median pore diameter in the range of 0.1 nm to 500 nm constructed from TiO₂ nanoparticles, the nanoporous film member adhered to a conductive support member,
a cathode,
a housing member having an inlet and outlet adapted to house the anode and cathode,
a light source assembly adapted to emit ultraviolet light to the photoelectrocatalytic composite photoanode, and,
an electrical power source adapted to apply a voltage across the photoelectrocatalytic composite photoanode and cathode in the range of −1 V to +12 V.

2. The photoelectrocatalytic oxidation device of claim 1, wherein the median pore diameter is in the range of 0.3 nm to 25 nm.

3. The photoelectrocatalytic oxidation device of claim 1, wherein the nanoporous film member has an average thickness in the range of 1 nm to 2000 nm.

4. The photoelectrocatalytic oxidation device of claim 1, wherein the nanoporous film member is constructed from a stable dispersed suspension comprising TiO₂ nanoparticles having a median primary particle diameter in the range of 0.3 nm to 50 nm.

5. The photoelectrocatalytic oxidation device of claim 4, wherein the nanoporous film member is constructed from a stable suspension further comprising a doping agent.

6. The photoelectrocatalytic oxidation device of claim 5, wherein the doping agent is Pt, Ni, Au, V, Sc, Y, Nb, Ta, Fe, Mn, Co, Ru, Rh, P, N or C.

7. The photoelectrocatalytic oxidation device of claim 1, wherein the conductive support member is annealed Ti foil.

8. The photoelectrocatalytic oxidation device of claim 1, wherein the nanoporous film member is constructed by applying a stable, dispersed suspension comprising TiO₂ nanoparticles therein, and, wherein the TiO₂ nanoparticles are sintered at a temperature in the range of 300° C. to 1000° C. for 0.5 hour to 10 hours to produce the nanoporous film member.

9. The photoelectrocatalytic oxidation device of claim 1, wherein the photoelectrocatalytic composite photoanode is cylindrical in shape.

10. The photoelectrocatalytic oxidation device of claim 1, wherein the cathode is constructed from Pt, Ti, Ni, Au, stainless steel or C.

11. The photoelectrocatalytic oxidation device of claim 10, wherein the cathode is in the shape of a wire, plate or cylinder.

12. The photoelectrocatalytic oxidation device of claim 1, further comprising a reference electrode and a voltage control device adapted to maintain a constant voltage and/or constant current between the reference electrode and the photoelectrocatalytic composite photoanode, wherein the housing member is adapted to house the reference electrode.

13. The photoelectrocatalytic oxidation device of claim 1, further comprising a carbon filter adapted to filter chlorine from the water and a computer adapted to send a controlled signal to the electrical power source to pulse the voltage and current, wherein the voltage control device is a potentiostat.

14. The photoelectrocatalytic oxidation device of claim 1, wherein the housing member is adapted to house the light source assembly, and wherein the electrical power source is adapted to generate an electrical potential in the range of 1.2 to 3.5 V across the photoelectrocatalytic composite photoanode and cathode.

15. The photoelectrocatalytic oxidation device of claim 1, wherein the light source assembly comprises a lamp or bulb and a transparent quartz or fused silica member adapted to house the lamp, and wherein the ultraviolet light has a wavelength in the range of 200-380 nm.

16. The photoelectrocatalytic oxidation device of claim 15, wherein the lamp is a low pressure mercury vapor lamp adapted to emit UV germicidal irradiation at 254 nm wavelength.

17. The photoelectrocatalytic oxidation device of claim 16, wherein the lamp is adapted to emit an irradiation intensity in the range of 1 mW/cm² to 500 mW/cm².

18. The photoelectrocatalytic oxidation device of claim 1, wherein the light source assembly is disposed exterior to the housing member, and, wherein the housing member further comprises a transparent member adapted to permit ultraviolet light emitted from the light source assembly to irradiate the photoelectrocatalytic composite photoanode.

19. A method of reducing the amount and concentration of ammonia in an aquarium or aquaculture comprising:
providing an aqueous solution comprising water, NH₃, NH₄⁺ and 1 ppb to 200 g/L NaCl, and,
photoelectrocatalytically oxidizing the NH₃ and NH₄⁺ to produce N₂ gas, NO₂⁻ and NO₃⁻,
wherein the NH₃ and NH₄⁺ are oxidized on, or proximate to, the surface of a photoanode constructed from an anatase polymorph of Ti, a rutile polymorph of Ti, or a nanoporous film of TiO₂.

20. The method of claim 19, wherein the aqueous solution has a pH in the range of 5 to 10.

21. The method of claim 19, wherein the aqueous solution comprises 1 to 41 g/L NaCl.

22. The method of claim 19, wherein the aqueous solution comprises in the range of 0.05 ppb to 9 ppm NH₃ and NH₄⁺ as nitrogen.

23. The method of claim 19, wherein NH₃ and NH₄⁺ are photoelectrocatalytically oxidized by a voltage in the range of −1 V to +12 V.

24. The method of claim 19, wherein NH₃ and NH₄⁺ are photoelectrocatalytically oxidized by sunlight or ultraviolet light having a wavelength in the range of 200 to 380 nm.

25. The photoelectrocatalytic oxidation device of claim 1, wherein the photoelectrocatalytic anode is constructed from an anatase polymorph of Ti or a rutile polymorph of Ti.

26. The photoelectrocatalytic oxidation device of claim 1, wherein the photoelectrocatalytic anode is constructed from the rutile polymorph of Ti.

27. The photoelectrocatalytic oxidation device of claim 26, wherein the rutile polymorph of Ti is constructed by heating an anatase polymorph of Ti at a temperature in the range of 400° C. to 1000° C. for a sufficient duration.

28. The photoelectrocatalytic oxidation device of claim 26, wherein the anatase polymorph of Ti is heated at 500° C. to 600° C. for a sufficient duration to produce the rutile polymorph of Ti.

29. The photoelectrocatalytic oxidation device of claim 1, wherein the housing is adapted to permit sunlight to illuminate both the anode or a solar cell adapted to provide the voltage applied across the photoelectrocatalytic composite photoanode and cathode.

30. The photoelectrocatalytic oxidation device of claim 1, wherein the device is adapted to be used in a closed, recirculating aquaculture system.
